(19) United States
(12) Patent Application Publication
(10) Pub. No.: US 2022/0253410 A1
(43) Pub. Date: Aug. 11, 2022

(54) SUSPENSION OF DATABASE MAINTENANCE USING PARALLEL PROCESSING TECHNIQUES

(71) Applicant: Humana Inc., Louisville, KY (US)

(72) Inventors: Sean D. Haarsager, Louisville, KY (US); James Darrell Dillon, Louisville, KY (US)

(21) Appl. No.: 17/180,934

(22) Filed: Feb. 22, 2021

Related U.S. Application Data
(63) Continuation of application No. 17/170,981, filed on Feb. 9, 2021.

(51) Int. Cl. G06F 16/21; G06F 16/25; G06F 9/54; G06F 9/48

(52) U.S. Cl. CPC G06F 16/21; G06F 9/4881; G06F 9/546; G06F 16/25

(57) ABSTRACT

An adaptive maintenance technique using multiple simultaneous, dedicated, process executions to perform database management. Parallel execution of dedicated database maintenance processes organized by object groups provides logical channel isolation (preventing command conflicts) and minimizes the time for maintenance processing while allowing for larger business processing windows even as the database grows in size and processing demand increases. The simultaneous and parallel database maintenance processes are configured to allow suspension of maintenance midstream and the setting of maintenance windows to predetermined time periods.

### CROSS-REFERENCE TO RELATED APPLICATION

This application is a continuation of non-provisional application Ser. No. 17/170,981, filed Feb. 9, 2021, the disclosure of which is hereby incorporated by reference in its entirety as if fully recited herein.

### BACKGROUND OF THE INVENTIVE FIELD

The present invention is directed to a database maintenance technique that uses a novel parallel processing technique and dedicated object maintenance channels to minimize the time for maintenance processing while allowing for larger business processing windows even as the database grows in size and processing demand increases.

In the last 4 years, total data storage for SQL server databases has grown from 1.75 Petabytes (10¹⁵ bytes, or 1,000,000 Gigabytes) to 3.03 Petabytes, a growth of 73%. That equates to about 6 Terabytes of additional storage needed every week. As the data grows, database maintenance plays an increasingly vital role in maintaining the health and safety of the data in the databases and the underlining platforms that serves them. Maintenance takes away processing time and power from business tasks and requires more resources (e.g., larger and more expensive hardware) as the data grows. These elements directly impact business efficiency and overhead cost. The SQL (Structured Query Language) server maintenance framework often strains under the sheer volume and growth of data and a new technique is necessary to continue the high efficiency and availability of these data services, especially for business-focused processing.

The adaptive maintenance technique of the present invention leverages a parallel processing path and available computing to cut the maintenance processing window by greater than 50%, thus opening up additional time that can be used by the application for business-supporting processes while reducing the overall cost of system operation. This maintenance strategy is a holistic solution and encompasses elements from across the development lifecycle. The overall strategy constructs a universal maintenance implementation flexible and smart enough to supply a full range of SQL server capabilities, reduces the time necessary to conduct maintenance, and provides for future growth of these database systems.

Adaptive maintenance allows for maintenance on thousands of databases being managed without the necessary increase in human resources. Removing the human bottleneck through automation alone does not, however, remove the other bottlenecks that exist within the maintenance process: e.g., serial command execution. The serial execution of commands extends out the time necessary to complete maintenance (e.g., database consistency checks and index optimizations). In some instances, the time increases start to conflict with other business critical operations. When analyzing available server resources during maintenance processing, the servers' resources are not being leveraged to their full potential. The nature of traditional SQL server maintenance is serial (one task at a time), but it is possible to parallel out the work such that multiple processes could be executed simultaneously. It is this parallel processing that allows the leveraging of more platform resources for a given unit of time. Other benefits and features that could be provided by a parallel, asynchronous approach are:
1. Maintenance Pause—Maintenance could be interrupted midstream without losing the locus within the overall maintenance plan.
2. Hard Time Windows—Because maintenance can be interrupted, a set operational window can be set and maintained. It is also possible to set multiple windows for a single day period.
3. Variable Process Assignment—The number of processes devoted to maintenance can be set dynamically, thus allowing specialization based on each platform's resource allocation. The number of channels can be configured at a server level allowing each server to be customized as far as how much computing to leverage. More simultaneous channels will leverage higher levels of computing. This can also be done dynamically via a stored procedure call.
4. Dedicated Object Channels—Each storage object is dedicated to a channel which eliminates collisions during the maintenance process. In the preferred embodiment, an object can be any database object that stores data or indexes (e.g., tables or materialized views).

The end result is a drastic cut in the required maintenance window (where business processes can't run) allowing for time for more and complex business processes to run in order to support strategic goals. Overall maintenance time in production is reduced by about 66% and the average server time (against the moving average) is reduced by about 75%. In one embodiment, the overall production maintenance time can be reduced from about 175,000 minutes a day to about 55,000 minutes a day, while average maintenance time on server on a per server basis is reduced from about 240 minutes a night to about 60 minutes a night. This provides more processing power and time to the business processes without any additional cost.

### SUMMARY OF THE GENERAL INVENTIVE CONCEPT

In one embodiment of the invention, the present invention allows a plurality of separate server processes to run simultaneously and in parallel (e.g., 10 dedicated server processes). At start there are 0 processes dedicated to the processing. The queue of the present invention is enabled and retrieves the first message in the queue, identifies the object group, instantiates a new process and hands (or assigns) that process to the identified object group for processing. This repeats until there are multiple processes (up to 10 in one example) running at the same time. As one of these dedicated server processes finishes all messages/commands associated with the assigned object group, the process completes and shuts down. The queue sees that there are only 9 dedicated processes, and instantiates a new process and assigns the next object group. Eventually there would be no more messages/commands and all the object groups are either assigned or completed, at which point no new processes would be instantiated.

In one embodiment of the invention, the invention is comprised of a method for adaptive maintenance of a database having database objects using dedicated logical channels, the method comprising the steps of: retrieving data describing maintenance details of the database; generating commands or messages from the data describing maintenance details of the database; storing the commands or messages at an intermediary command or message queue; grouping or categorizing the commands or messages stored at the intermediary command or message queue into a plurality of groups based on objects of the database being maintained, these plurality of groups being object groups; assigning or associating each of the plurality of object groups to one of a plurality of dedicated server processes to create a plurality of dedicated, parallel, processes for maintaining the database; retrieving the commands or messages stored at the intermediary command or message queue; executing the commands or messages from the plurality of object groups in a dedicated, parallel, fashion to perform database maintenance on the database; and suspending acquisition of commands or messages from the intermediary command or message queue by preventing queue command or message processing.

In one embodiment, the method of the present invention is also comprised of the steps of: grouping or categorizing the commands or messages stored at the intermediary command or message queue into a plurality of object groups by assigning a unique identification to all commands or messages associated with the same object group; and setting at least one window of time for database maintenance by starting and suspending maintenance at a predetermined period of time.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates two patterns of database maintenance;

FIG. 2 illustrates a typical flow of standard database maintenance (prior art);

FIG. 3 illustrates an exemplary process of the present invention by which commands are generated;

FIG. 4 illustrates an exemplary process of organizing, initiating, and executing of commands of the present invention;

FIG. 5 illustrates one example process of suspending maintenance operations of the present invention;

FIG. 6 illustrates an example flow showing the message creation and processing functions of the service broker operations of the present invention.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In one embodiment of the invention, the adaptive maintenance technique uses multiple simultaneous processes (e.g., server process ID (SPID) executions). The SPIDs are essentially sessions in SQL server processes. Every time an application connects to the SQL server, a new connection or dedicated server process (e.g., dedicated procedure instance or SPID) is initiated. Typically, the SPID has a defined scope and memory space and does not interact with other SPIDs.

Parallel execution according to the present invention provides logical channel isolation (preventing command conflicts). SQL Server maintenance has traditionally been a serial process; one table at a time and then only one sub-object (table or index) at a time. Adaptive maintenance of the present invention allows for multiple tables or objects to be worked on at the same time. The cost and limit is only capped by the amount of computing power that can be leveraged on the server itself.

Database maintenance plays a vital role in maintaining the health and safety of the data in a database and the underlining platform that serves it. Very large databases (VLDB's) have special concerns in relation to maintenance, especially in relation to the time and resources available. Traditional SQL server maintenance frameworks strain under the sheer volume and growth of data and a solution is necessary to continue the high efficiency and availability of these data services.

The maintenance strategy of the present invention is a holistic solution and encompasses elements from across the development life cycle. Each of these elements, alone or in combination, contribute to a more efficient solution:

1. properly structured (normalized) data;

2. efficient index plan and implementation;

3. server workload management;

4. proper infrastructure implementation and tuning;

5. maintenance execution mechanism.

The present invention provides a universal maintenance implementation flexible and smart enough to supply a full range of SQL server capabilities, reduces the time necessary to conduct maintenance, and provides for future growth of these database systems.

One of the traditional frameworks that provides maintenance is the Ola Hallengren scripts. This framework allows for automation of maintenance on thousands of databases without the necessary increase in human resources. Removing the human bottleneck through automation does not, however, remove the other bottlenecks that exist within the maintenance process such as serial command execution. The serial execution of commands extends out the time necessary to complete maintenance (database consistency checks and index optimizations). In some instances, the increase in time causes conflicts with other business critical operations.

When analyzing available server resources during maintenance processing in traditional systems, the servers' resources are not being leveraged to their full potential. The nature of the traditional database maintenance is serial (one task at a time). One aspect of the present invention relates to parallel processing of the work such that multiple processes could be executed simultaneously. Parallel processing allows the leveraging of more platform resources for a given unit of time.

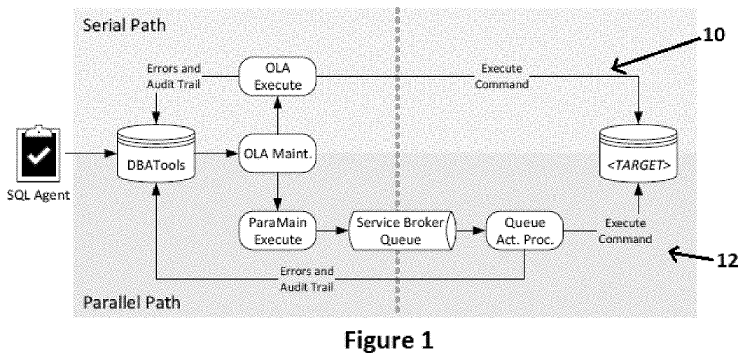

FIG. 1 illustrates two patterns to SQL server maintenance, standard (traditional) maintenance 10 and the adaptive maintenance 12 of the present invention:
1. Standard Maintenance—Commands are generated by maintenance scripts and executed one at a time (serial path). In between each step, the status is updated. Once maintenance is started, it can only be stopped by killing the underlying process(es) that it is being executed in.
2. Adaptive Maintenance—Commands are generated by maintenance scripts and sent to an intermediary queue. Multiple processes pull from the queue and execute the commands independently in object-aligned channels to reduce conflicts. The queue can be shut down and restarted.

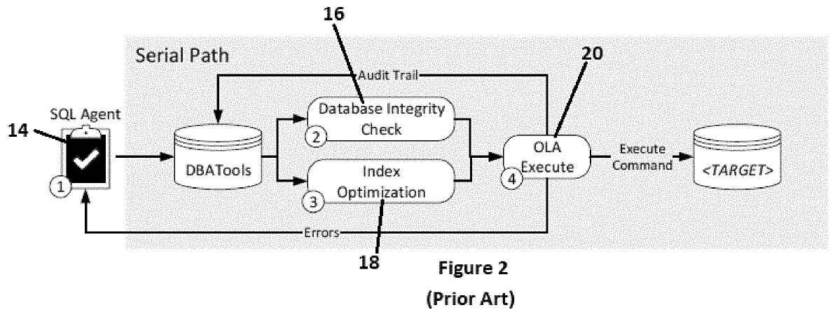

FIG. 2. illustrates a typical flow of standard database maintenance characterized by a sequence of commands generated from maintenance scripts and executed in line with their generation.

Standard maintenance is conducted in the following sequence:
1. Maintenance Initiation 14—SQL agent triggers a script that pulls meta data for each individual database. The meta data describes the maintenance details based on specific day of the week. The script uses the meta data to drive the OLA scripts.
2. Database Integrity Check 16 (DBCC)—Creates the necessary commands based on the meta data and executes these commands against the target database in sequence, logging results as the command is completed. In the preferred embodiment, a command is a task implemented by a message stored on the queue. A command is generated by all the associated meta data that describes what tasks need to occur for the object (e.g., type of maintenance).
3. Index Optimization 18—Initiated after the DBCC completes, creates the necessary commands based on the meta data and executes these commands against the target database in sequence, logging results as the command is completed.
4. Command Execution and Status Logging 20—As commands are being executed, pertinent data is logged and tracked.

Maintenance is generally executed on the server that the database runs on. Depending on the size of the database and its configuration (stand-alone, cluster, AG, etc.), the database integrity checks (DBCC) and maintenance can be conducted outside of the primary server (on a backup clone, on a secondary of an AG, etc.).

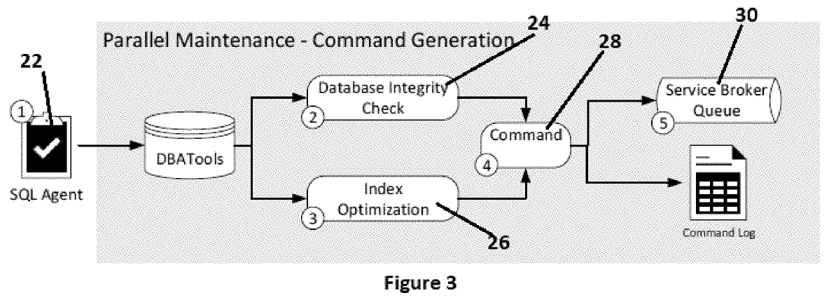

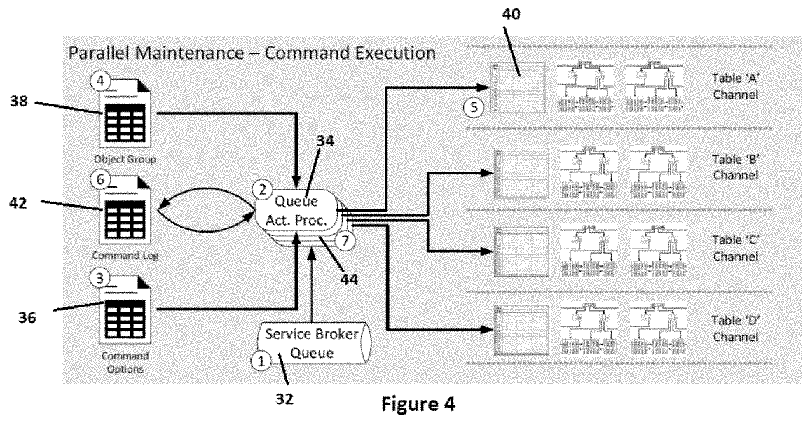

Adaptive maintenance preferably has two separate steps, command generation and command execution:
1. Command Generation—FIG. 3 illustrates an exemplary process of the present invention by which commands are generated by a maintenance scripts tool, channeled based on storage object, and sent to an intermediate queue.
2. Command Execution—FIG. 4 illustrates an exemplary process of organizing, initiating and executing of the commands generated from the maintenance scripts tool. The process manages flow control and errors while logging steps and work status.

Additionally, there are two additional control features that allow for operational flexibility.
3. Suspending Operation—Managing the command option values to suspend (halt) any commands that have not yet started.
4. Command Recycling—In the event of operations being halted by pausing or deactivating the execution queue, the unexecuted messages are maintained in the execution queue for future processing once the queue is reactivated.

Adaptive maintenance starts very much like the standard maintenance. Commands are generated based on the meta data, but instead of executing the commands directly routes them to a working queue:
1. Maintenance Initiation 22—SQL agent triggers a script that pulls meta data for each individual database. The meta data describes the maintenance details based on specific day of the week. The script uses the meta data to drive OLA scripts.
2. Database Integrity Check 24 (DBCC)—Creates the necessary SQL commands based on the meta data, wraps those in the necessary message structure and sends them to the execution queue for processing once the queue is activated.
   a. CHECKDB commands are automatically converted into CHECKTABLE commands to take advantage of smaller units of work for parallelization.
   b. A database snapshot is dynamically created prior to maintenance starting, allowing a TABLOCK option to be used with a CHECKTABLE command.
3. Index Optimization 26—Initiated after the DBCC completes, creates the necessary SQL commands based on the meta data, wraps those in a message structure and sends them to the execution queue for processing once the queue is activated.
4. Command Status Logging 28—Commands are logged and tracked as it is packaged and sent to the working queue. The commands are not being executed in this step. A procedure is initiated to route the commands to the working queue.
5. Commands are organized into logical channels based on individual storage objects (e.g., tables and materialized views) and stored in a working service broker queue 30. The organization of the commands into logical channels is preferably accomplished by first organizing the messages or commands for each database object into an object group by assigning a unique identification (ID) to all the messages or commands in the same object group. In one embodiment the unique ID can be a 40 character alphanumeric number, e.g, GUID. The unique ID is tied to every maintenance message or command of the same table or object. In one embodiment, an object group reflects a grouping of messages/commands for an object grouped together by way of both message cohesion (via the related conversation group) and tying it to an internal table that tracks the object group's table, the processing ID (SPID or actual OS process), and total message count.

Adaptive maintenance starts very much like the standard maintenance. Commands are generated based on the meta data, but instead of executing the commands directly routes them to a working queue:
1. Enable Queue 32—Place the working queue in a state of usability. Disabling a queue is the prime way to ‘halt’ maintenance runs before exhausting the commands in the working queue.
2. Enable Queue Activation Procedure 34—Used to trigger the procedure to start reading from the queue. Number of threads can be changed at any time by altering the number of queue readers. In the preferred embodiment, the queue reader is a part of the service broker and is an internal mechanism that manages the service broker reading from the queue. Threads are processes or SPID's and represent individual parallel process paths. Channels or object groups are used to ensure that all messages/commands targeting the same object do not conflict with each other by forcing all commands for the same individual object to run serially within a thread.
3. Check Processing State 36—Command options are used to set various options within the activation procedure.
   a. Verbose Logging—Enables detailed logging operations.
   b. Enable Queue—Enables/disables queue. Used to halt any new commands during queue operations.
4. Assign Object Group 38—As a queue reader is activated it checks the available queue messages against the next open object group. An open object group are any object groups that still have messages in the queue. The first (or top) unassigned object group is selected and assigned so that all messages in a channel is worked by a single dedicated server process. In the preferred embodiment, the open object group is assigned to a SPID. This creates the logical channel for the commands in the assigned object group to be connected to or associated with the SPID it is assigned to.
5. Channel Processing 40—Once an object group (logical channel) is assigned to a dedicated server process, the procedure preferably:
   a. Acquires all messages associated with the assigned object group.
   b. Executes the command in the message.
   c. Captures the success or failure of the execution.
   d. Logs an error(s) that occurred during processing.
   e. Checks to see if process needs to halt.
6. Command Status Log 42—As command is completed. Or encounters an error, its status is logged and tracked.
7. Channel Completion & Cleanup 44—Once all the tasks for logical channel are completed (e.g., by looping through all of the messages/commands in an object group), cleanup steps are completed:
   a. Releases (set to NULL) the SPID with in the object group associated with the logical channel.
   b. Drop Snapshot—If all commands for a particular database's snapshot are completed, the snapshot is dropped.

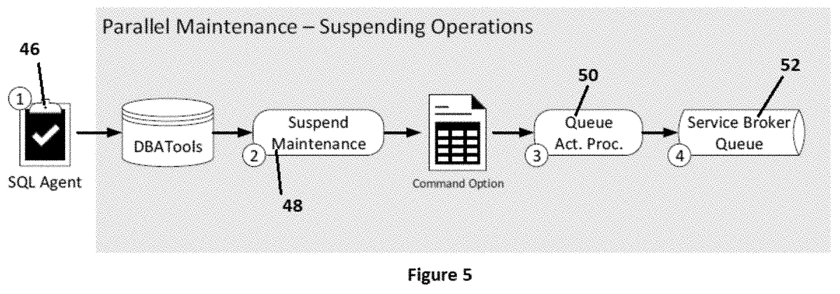

FIG. 5 illustrates one example process of suspending maintenance operations of the present invention. Adaptive maintenance can be safely interrupted midstream. This is preferably accomplished by setting the necessary command option to OFF, thus preventing queue message processing beyond those already started. Any command that has not yet started will not be pulled from the queue and will remain until the queue procedure is reactivated. The process to suspend maintenance processing preferably includes the following steps:
1. Suspension Initiation 46—Calls a procedure that sets the command option value that determines whether a queue's activation procedure is active.
2. Update Command Option 48—updates the ‘Activation’ meta data record to 0 (‘OFF’).
3. Suspend Command Execution 50—Queue activation procedure checks the ‘Activation’ command option. If it is set to 0 (‘OFF’), the activation procedure will go to a waiting state until all other procedure instances are in a wait state then the queue's activation procedure will be deactivated.
4. Disable Queue Activation Procedure 52—Once deactivated, messages will not trigger activation.

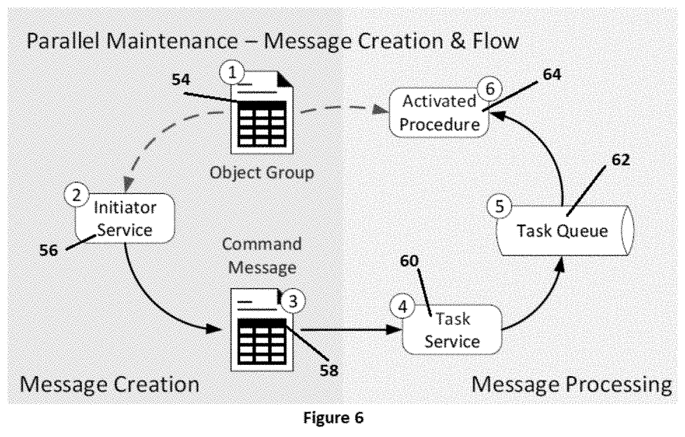

FIG. 6 illustrates an example flow showing the service broker operations of the present invention. Service broker operations are asynchronous and integral to adaptive maintenance processing. This can be split between two activities: message creation and message processing.

Message Creation
1. Object Group 54—An object group is a collection of maintenance items associated with a storable object (e.g., table, materialized view, columnstore index, etc.) that is assigned a universal ID (unique identifier or GUID) that is used for the conversation group when a message is created and sent.
2. Initiator Service 56—Each message is sent from the initiator service on the conversation group. This allows the grouping of object from within the same queue.
3. Command Message 58—The actual message containing the necessary information to carry out the task. Each message has a conversation handle that is tied back to the command log for tracking and auditing. The message is sent to the task service.

Message Processing
4. Task Service 60—The task service accepts incoming messages, storing them in the task queue.
5. Task Queue 62—The task queue holds the messages until they are pulled off and that conversation completed. Messages in the task queue will trigger the activation procedure if it is enabled.
6. Activation Procedure 64—The activation procedure is used to pull messages off the task queue, grouped by object group, and process the command contained in the message.

While certain embodiments of the present invention are described in detail above, the scope of the invention is not to be considered limited by such disclosure, and modifications are possible without departing from the spirit of the invention as evidenced by the following claims:

What is claimed is:

1. A method for adaptive maintenance of a database having database objects using dedicated logical channels, the method comprising the steps of:
retrieving data describing maintenance details of the database;
generating commands or messages from the data describing maintenance details of the database;
storing the commands or messages at an intermediary command or message queue;
grouping or categorizing the commands or messages stored at the intermediary command or message queue into a plurality of groups based on objects of the database being maintained, these plurality of groups being object groups;
assigning or associating each of the plurality of object groups to one of a plurality of dedicated server processes to create a plurality of dedicated, parallel, processes for maintaining the database;
retrieving the commands or messages stored at the intermediary command or message queue;
executing the commands or messages from the plurality of object groups in a dedicated, parallel, fashion to perform database maintenance on the database; and
suspending acquisition of commands or messages from the intermediary command or message queue by preventing queue command or message processing.

2. The method of claim 1, further comprising the step of:
grouping or categorizing the commands or messages stored at the intermediary command or message queue into a plurality of object groups by assigning a unique identification to all commands or messages associated with the same object group.

3. The method of claim 1, further comprising the step of:
setting at least one window of time for database maintenance by starting and suspending maintenance at a predetermined period of time.

4. The method of claim 1, further comprising the step of:
dynamically setting a number of processes devoted to maintenance by setting the number of object groups or dedicated server processes that can run at a time.

5. The method of claim 1, further comprising the step of:
recycling commands or messages that were cleared out from the intermediary command or message queue without being executed.

6. The method of claim 1, further comprising the steps of:
maintaining any unexecuted commands or messages in the intermediary command or message queue;
reactivating a queue activation procedure;
acquiring the unexecuted commands or messages in the intermediary queue; and
executing the unexecuted commands or messages to complete database maintenance.

7. The method according to claim 1, wherein each of the object groups reflects a grouping of messages or commands grouped together by way of both message cohesion, and further comprising the step of:
tying each object group to an internal table that tracks a processing identification and a total message count.

8. The method of claim 1, further comprising the step of:
running the plurality of dedicated server processes simultaneously and in parallel so as to create separate logical channels for database maintenance.

9. The method of claim 1, wherein the plurality of dedicated server processes are simultaneous procedure instances or server process ID (SPID) executions.

10. The method of claim 1, further comprising the step of:
organizing the commands of messages into logical channels by assigning them to separate object groups and connecting them to separate dedicated server processes.

11. The method of claim 1, further comprising the step of:
changing the number of dedicated logical channels by altering the number of queue readers available to read from the intermediary command or message queue.

12. The method of claim 1, further comprising the step of:
releasing the plurality of dedicated server processes when all commands or messages associated with each dedicated server process is completed.

13. The method of claim 1, further comprising the step of:
suspending maintenance of the database midstream by preventing queue command processing

14. A method for adaptive maintenance of a database having database objects using dedicated logical channels, the method comprising the steps of:
retrieving data describing maintenance details of the database;
generating commands or messages from the data describing maintenance details of the database;
storing the commands or messages at an intermediary command or message queue;
grouping or categorizing the commands or messages stored at the intermediary command or message queue into a plurality of groups based on objects of the database being maintained, these plurality of groups being object groups;
assigning or associating each of the plurality of object groups to one of a plurality of dedicated server processes to create a plurality of dedicated, parallel, processes for maintaining the database;
retrieving the commands or messages stored at the intermediary command or message queue;
executing the commands or messages from the plurality of object groups in a dedicated, parallel, fashion to perform database maintenance on the database; and
setting at least one window of time for database maintenance by starting and suspending maintenance at a predetermined period of time.

15. The method of claim 14, further comprising the step of:
suspending acquisition of commands or messages from the intermediary command or message queue by preventing queue command or message processing.

16. The method of claim 14, further comprising the steps of:
maintaining any unexecuted commands or messages in the intermediary command or message queue;
reactivating a queue activation procedure;
acquiring the unexecuted commands or messages in the intermediary queue; and
executing the unexecuted commands or messages to complete database maintenance.

17. A method for adaptive maintenance of a database having database objects using dedicated logical channels, the method comprising the steps of:
generating commands or messages for the purpose of providing maintenance on database objects stored at the database;
storing the commands or messages at an intermediary command or message queue;
grouping or categorizing the commands or messages stored at the intermediary command or message queue into a plurality of groups based on objects of the database being maintained, these plurality of groups being object groups;
assigning or associating each of the plurality of object groups to one of a plurality of dedicated server processes to create a plurality of dedicated, parallel, processes for maintaining the database;
retrieving the commands or messages stored at the intermediary command or message queue;
executing the commands or messages from the plurality of object groups in a dedicated, parallel, fashion to perform database maintenance on the database; and
suspending acquisition of commands or messages from the intermediary command or message queue by preventing queue command or message processing.

18. The method of claim 17, further comprising the step of:
setting at least one window of time for database maintenance by starting and suspending maintenance at a predetermined period of time.

19. The method of claim 17, further comprising the steps of:
maintaining any unexecuted commands or messages in the intermediary command or message queue;
reactivating a queue activation procedure;
acquiring the unexecuted commands or messages in the intermediary queue; and
executing the unexecuted commands or messages to complete database maintenance.

20. The method of claim 17, further comprising the step of:
changing the number of plurality of dedicated server processes by altering the number of queue readers available to read from the intermediary command or message queue.
